(19) United States
(12) Patent Application Publication
(10) Pub. No.: US 2015/0360216 A1
(43) Pub. Date: Dec. 17, 2015

(54) PROCESS AND APPARATUS FOR FLUIDIZING A REGENERATOR

(71) Applicant: UOP LLC, Des Plaines, IL (US)

(72) Inventors: Paolo Palmas, Des Plaines, IL (US); Richard A. Johnson, II, Algonquin, IL (US)

(21) Appl. No.: 14/302,667

(22) Filed: Jun. 12, 2014

(51) Int. Cl. B01J 38/02

(52) U.S. Cl. CPC B01J 38/02

(57) ABSTRACT

Disclosed is a process and apparatus for recycling flue gas from a regenerator back to the regenerator to provide fluidization gas needs. Catalyst may be separated from the flue gas before recycle and the flue gas may be compressed before recycle to the regenerator. The process and apparatus reduces the size capacity of downstream product recovery equipment by reducing gases derived by oxidation in the process and reduces the potential for after burn in the regenerator.

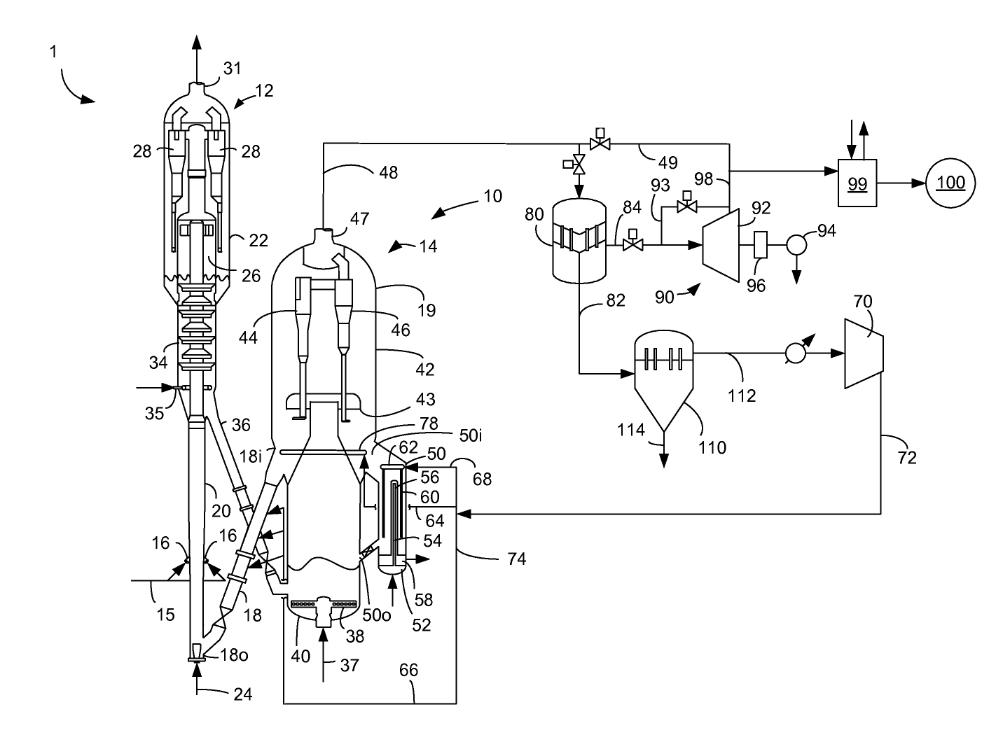

### BACKGROUND

The field is catalyst regeneration in a fluid catalytic cracking (FCC) unit.

FCC technology has undergone continuous improvement and remains the predominant source of gasoline production in many refineries. This gasoline, as well as lighter products, is formed as the result of cracking heavier (i.e., higher molecular weight), less valuable hydrocarbon feed stocks such as gas oil.

In its most general form, the FCC process comprises a reactor that is closely coupled with a regenerator, followed by downstream hydrocarbon product separation. Hydrocarbon feed contacts catalyst in the reactor to crack the hydrocarbons down to smaller molecular weight products. During this process, coke tends to accumulate on the catalyst. Coke must be burned off of the catalyst in a regenerator.

The heat of combustion in the regenerator typically produces flue gas at temperatures of 677° to 788° C. (1250° to 1450° F.) and at a pressure range of 138 to 276 kPa (20 to 40 psig). Although the pressure is relatively low, the extremely high temperature, high volume of flue gas from the regenerator contains sufficient kinetic energy to warrant recovery of energy. Flue gas may be fed to a power recovery unit, which may include an expander turbine. The kinetic energy of the flue gas is transferred through blades of the expander to a rotor coupled either to a main air blower, to produce combustion air for the FCC regenerator, and/or to a generator to produce electrical power. The flue gas may also be run to a steam generator for further energy recovery. A power recovery train may include several devices, such as an expander turbine, a generator, an air blower, a gear reducer, and a let-down steam turbine.

In order to reduce damage to components downstream of the regenerator, it is also known to remove flue gas solids. This is commonly accomplished with first and second stage separators, such as cyclones, located in the regenerator. Some systems also include a third stage separator (TSS) or even a fourth stage separator (FSS) to further remove fine particles, commonly referred to as “fines”.

In regenerators, fluffing air may be injected to the regenerator for fluidization of catalyst in stagnant areas. In combustor regenerators the fluffing air is injected into the upper chamber and may account for as much as 2 wt % of the total air requirement for catalyst combustion. The excess oxygen can lead to after burn in the regenerator. After burn refers to combustion of carbon monoxide to carbon dioxide. After burn can be particularly dangerous in the upper chamber of a combustor regenerator because less catalyst is present in the dilute phase to absorb the heat generated by the combustion. Instead, heat can be absorbed by the equipment thereby causing severe damage.

Additionally, non-condensable, non-hydrocarbon gases derived from air, principally oxygen, carbon monoxide, carbon dioxide and nitrogen can be entrained with regenerated catalyst flowing in a regenerator conduit from the regenerator to the reactor riser. These gases are inert to catalytic cracking and can concentrate in the reactor off gas that has to be recovered from the FCC unit. These inert gases are undesirable because they take up capacity in the fuel gas amine treating unit and the acid gas recovery unit for treating FCC off-gases. Additionally, these inert gases can end up in off-gas products which are undesirable to a refiner. It would be desirable to reduce the potential for after burn in an FCC regenerator and to reduce inert gas treatment capacity in an FCC recovery section.

### SUMMARY

We have discovered a process and apparatus that substitutes all or part of the fluidization air traditionally used in catalyst fluidization distributors and catalyst cooler aeration lances with flue gas to reduce certain entrained inert gases in FCC off gas to reduce capacity impacts on downstream equipment and process units and to reduce the potential for after burn in the regenerator dilute phase. We propose to use regenerator flue gas to meet these fluidization needs.

In a process embodiment, the invention comprises a process for regenerating catalyst comprising combusting coke from spent catalyst in a regenerator to provide regenerated catalyst and flue gas. The flue gas is discharged from the regenerator and catalyst is separated from the flue gas discharged from the regenerator. The flue gas is recycled gas to the regenerator.

In an apparatus embodiment, the invention comprises an apparatus for regenerating catalyst comprising a regenerator for combusting coke from spent catalyst and a flue gas line in communication with the regenerator for discharging flue gas. A compressor in downstream communication with the flue gas line and the regenerator in downstream communication with the compressor.

Additional features and advantages of the invention will be apparent from the description of the invention, FIGURES and claims provided herein.

### BRIEF DESCRIPTION OF THE DRAWING

The FIGURE is a schematic drawing of an FCC unit of the present invention.

### DEFINITIONS

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without undergoing a compositional change due to physical fractionation or chemical conversion.

The term “bypass” means that the object is out of downstream communication with a bypassing subject at least to the extent of bypassing.

As used herein, the term “separator” means a vessel which has an inlet and at least two outlets.

As used herein, the term “predominant” or “predominate” means greater than 50 wt %, suitably greater than 75 wt % and preferably greater than 90 wt %.

As used herein, the term “a component-rich stream” means that the rich stream coming out of a vessel has a greater concentration of the component than the feed to the vessel.

### DETAILED DESCRIPTION

Now turning to the FIGURE, wherein like numerals designate like components, the FIGURE illustrates a process and apparatus 1 for fluid catalytic cracking (FCC). An FCC unit 10 includes a reactor 12 and a regenerator 14. Process variables typically include a cracking reaction temperature of 400° to 600° C. and a catalyst regeneration temperature of 500° to 900° C. Both the cracking and regeneration occur at an absolute pressure below 5 atmospheres.

The FIGURE shows a typical FCC process unit, in which a heavy hydrocarbon feed or raw oil stream in a line 15 is distributed by distributors 16 into a riser 20 to be contacted with a newly regenerated cracking catalyst entering from a regenerator conduit 18. This contacting may occur in the narrow riser 20, extending upwardly to the bottom of a reactor vessel 22. The contacting of feed and catalyst is fluidized by gas from a fluidizing line 24. Heat from the catalyst vaporizes the hydrocarbon feed, and the hydrocarbon feed is thereafter cracked to lighter molecular weight hydrocarbons in the presence of the catalyst as both are transferred up the riser 20 into the reactor vessel 22. The cracked light hydrocarbon products are thereafter separated from the cracking catalyst using cyclonic separators which may include a rough cut separator 26 and one or two stages of cyclones 28 in the reactor vessel 22. Product gases exit the reactor vessel 22 through a product outlet 31 for transport to a product recovery section which is not shown. Inevitable side reactions occur in the riser 20 leaving coke deposits on the catalyst that lower catalyst activity. The spent catalyst requires regeneration for further use. Coked catalyst, after separation from the gaseous product hydrocarbon, falls into a stripping section 34 where steam is injected through a nozzle 35 to a distributor to purge any residual hydrocarbon vapor. After the stripping operation, the coked catalyst is fed to the catalyst regenerator 14 through a spent catalyst conduit 36.

The FIGURE depicts a regenerator 14 comprising a regenerator vessel 19 known as a combustor. However, other types of regenerators are suitable. In the catalyst regenerator 14, a stream of oxygen-containing gas, such as air, is introduced from a line 37 through an air distributor 38 to contact the spent catalyst in a first, lower chamber 40, combust coke deposited thereon, and provide regenerated catalyst and flue gas. The catalyst regeneration process adds a substantial amount of heat to the catalyst, providing energy to offset the endothermic cracking reactions occurring in the riser 20. Catalyst and air flow upwardly together along a combustor riser located within the catalyst regenerator 14 and, after regeneration, are initially disengaged by discharge into an upper chamber 42 through a disengager 43. Finer separation of the regenerated catalyst and flue gas exiting the disengager 43 is achieved using first and second stage separator cyclones 44, 46, respectively within the upper chamber 42 of the catalyst regenerator 14. Catalyst separated from flue gas dispenses through a diplegs from cyclones 44, 46 while flue gas relatively lighter in catalyst sequentially exits cyclones 44, 46 and is discharged from the regenerator vessel 14 through a flue gas outlet 47 in a flue gas line 48.

Regenerated catalyst may be recycled back to the reactor 12 through the regenerator conduit 18. The riser 20 of the reactor 12 may be in downstream communication with the regenerator vessel 19 of the regenerator 14. The regenerator conduit has an inlet end 18i connecting to the regenerator vessel 19, in an aspect the upper chamber 42 of the regenerator vessel 19, for receiving regenerated catalyst therefrom and an outlet end 18o connecting to the riser 20 of the reactor 12 for transporting regenerated catalyst to the riser 20 of the reactor 12. As a result of the coke burning, the flue gas vapors exiting at the top of the catalyst regenerator 14 in the flue gas line 48 contain SOₓ, NOₓ, CO, CO₂, N₂, O₂ and H₂O, along with smaller amounts of other species. Additionally, some of these species may exit with regenerated catalyst exiting in a regenerator conduit 18 and enter the riser 20 of the reactor 12.

The regenerator 14 may include a catalyst cooler 50 in downstream communication with the regenerator 14 and particularly the regenerator vessel 19. Catalyst is transported from the regenerator 14, particularly the regenerator vessel 19, into the catalyst cooler 50. In a combustor regenerator shown in the FIGURE, regenerated catalyst may be transported from the upper chamber 42 into the lower chamber 40 of the regenerator vessel 19 through the catalyst cooler 50 and/or through recycle conduits that are not shown. Regenerated catalyst enters the catalyst cooler 50 through an inlet 50i. Regenerated catalyst may exit the catalyst cooler back through the inlet 50i or through an outlet 50o which introduces cooled, regenerated catalyst back into the lower chamber 40. Water may be fed to an inlet chamber 52 of the catalyst cooler 50. The catalyst cooler 50 includes a plurality of inner tubes 54 nested within respective outer tubes 56 of both only one is shown, respectively. Liquid water or lower pressure steam travels up the inner tube 54 into the interior of the catalyst cooler 50, absorbs heat from the hot, regenerated catalyst, cools the regenerated catalyst, and the liquid water vaporizes to steam or lower pressure steam upgrades to higher pressure steam. The steam travels down the outer tube 56 into the outlet chamber 58 and exits the catalyst cooler 50. Fluidization lances 60 receive fluidization gas from a distributor 62 for fluidizing regenerated catalyst in the catalyst cooler 50. An example of a catalyst cooler is provided in U.S. Pat. No. 5,027,893.

Hot flue gas is discharged from the regenerator 14 through the flue gas outlet 47 into a flue gas line 48 in downstream communication with the regenerator 14. An object is to recycle flue gas to the regenerator 14 for fluidization of catalyst in the regenerator 14. To use flue gas to fluidize catalyst in the regenerator 14, the flue gas must be compressed in a compressor 70 before it is recycled to the regenerator 14. Catalyst particles can damage the blades or other equipment in a compressor, so catalyst particles must be separated from the flue gas discharged from the regenerator 14 in flue gas line 48 before compression and recycling the flue gas to the regenerator 14.

A separator may be in downstream communication with the flue gas line 48 for separating regenerated catalyst from the flue gas. Catalyst particles may be separated from discharged flue gas in line 48 by any suitable device. Suitable separators include third stage separators (TSS) which comprises a vessel containing multiple cyclone separators, a fourth stage separator (FSS) which comprises a single cyclone separator exterior to the regenerator vessel 19, a barrier filter which may comprise a vessel containing one or multiple barrier filter elements, an electrostatic precipitator (ESP) which comprises one or more electrically charged electrodes in a vessel to which the catalyst is attracted from the flue gas and a scrubber which washes the flue gas with an aqueous solution to absorb SOₓ and NOₓ and also absorb the catalyst particles from the flue gas. A suitable barrier filter is available from Pall Corporation headquartered in Port Washington, N.Y. A suitable ESP is available from Hamon & Cie International with an office in Mont-St-Guibert, Belgium. A suitable scrubber is available from DuPont BELCO headquartered in Parsippany, N.J. The separator used should reduce the particulates in the flue gas stream down to no more than 100 wppm, suitably no more than 25 wppm and preferably no more than 10 wppm.

A suitable flue gas recycle process and apparatus is illustrated in the FIGURE although others may be suitable. A TSS 80 may be the separator that is in downstream communication with the regenerator 14. Flue gas discharged in flue gas line 48 may be delivered to the TSS 80 which removes catalyst from flue gas discharged from the regenerator by cyclonic separation. The flue gas line 48 may feed flue gas through an isolation valve to the TSS 80. In the event of upset or other abnormality, flue gas may also bypass the TSS 80 in bypass line 49 through a control valve thereon. The TSS 80 is a vessel that contains a plurality of cyclone separators, which remove a predominance of remaining catalyst particles by centripetal acceleration from the flue gas into an underflow gas line 82. The TSS 80 comprises two tube sheets with a plurality of cyclones extending through the tube sheets. In an aspect, inlets to the cyclones are above both tube sheets, dirty gas outlets of the cyclones are provided between the tube sheets and clean gas outlets are provided below the tube sheets. Clean flue gas exits the TSS 80 in a clean gas line 84. Reference may be had to U.S. Pat. No. 7,316,733 for an example of a TSS vessel. It is also contemplated that a TSS may be located in the regenerator vessel 19. Typically, at least 1 wt % but no more than 10 wt % and preferably no more than 5 wt % of the flue gas that enters the TSS 80 will exit the TSS as dirty gas in the underflow gas line 82 laden with separated regenerated catalyst.

Flue gas in the clean gas line 84 exiting the TSS 80 may enter a power recovery section 90. The clean flue gas in line 84 may have no more than about 120 and preferably no more than about 50 wppm particulates of which a largest dimension is no more than 20 microns. The power recovery section 90 is in downstream communication with the flue gas outlet 47 via the flue gas line 48 and the TSS 80 via clean gas line 84. Many types of power recovery configurations are suitable, and the following embodiment is very well suited but not necessary to the present invention.

In order to generate electricity, the power recovery section 90 includes a power recovery expander 92, which is typically a turbine, and a power recovery generator 94. More specifically, the expander 92 has an output shaft that is typically coupled to an electrical generator 94 by driving a gear reducer 96 that in turn drives the generator 94. The generator 94 provides electrical power that can be used as desired within the plant or externally. Alternatively, the expander 92 may be coupled to a main air blower for providing combustion gas to the regenerator 14, but this arrangement is not shown.

To control flow flue gas between the TSS 80 and the expander 92, an expander inlet control valve and a throttling valve (only one is shown) on line 84 may be provided upstream of the expander 92 to further control the gas flow entering an expander inlet. Additionally, a portion of the clean flue gas stream can be diverted in a bypass line 93 in case of an abnormality from a location upstream of the expander 92, through a bypass valve to join the flue gas in the exhaust line 98. The exhausted clean flue gas in line 98 joins the flowing waste gas from the bypass line 49 and flows to a steam generator 99 and to the outlet stack 100. Optionally, the combined stream of exhausted clean flue gas and waste gas may be scrubbed in a scrubber and/or have catalyst particulates further removed in an ESP before it is exhausted to the atmosphere in the outlet stack 100.

In some cases, a separated flue gas stream may be taken as a portion of the exhausted clean flue gas to the compressor 70 such as in lines 84 or 98, particularly if no other separator is used. However, in the embodiment of the FIGURE, an additional separator is used, so the dirty gas stream in underflow line 82 may be further separated to provide the flue gas recycle stream to the regenerator 14.

The dirty gas stream in underflow line 82 may comprise at least 1 wt % but no more than about 10 wt %, typically no more than about 5 wt %, suitably no more than about 4 wt % of the flue gas fed to the TSS 80 in line 48. The underflow gas in line 82 may have catalyst removed from it in an optional fourth stage separator (not shown) which comprises an additional cyclone separator. In an embodiment, a filter 110 can be provided as a separator to further remove catalyst that exit the TSS 80 in the dirty gas stream in underflow line 82 by filtration. In the embodiment of the FIGURE, the filter 110 is in downstream communication with the TSS 80 through the underflow line 82. It is also contemplated that the filter 110 replace the TSS 80 in which case only a portion of the filtered flue gas may be recycled back to the regenerator 14.

The filter 110 may comprise a single barrier filter. In an embodiment, the filter 110 comprises a barrier filtration vessel that includes a tube sheet through which a plurality of barrier elements extend. The dirty flue gas stream in line 82 may enter the barrier filtration vessel below the tube sheet. The barrier elements may comprise tubes or cylinders of sintered metal, ceramic or fabric that block solids but allow gas to travel from one end of the barrier element on one side of the tube sheet, across the tube sheet to the other end of the barrier element on the other side of the tube sheet. The barrier elements typically have a closed bottom end and an outlet in the top end for the separated, filtered gas. Separated, filtered gas exits the filter 110 in a separated line 112 while catalyst particles are removed in line 114 to be further collected for disposal.

It is advantageous to keep flue gas below 1200° F. (649° C.) before entering the filter 110 and this may be done by keeping the line 82 between the TSS 80 and the filter 110 uninsulated, so heat is absorbed from the line 82 by the ambient air. It is contemplated to further cool the flue gas stream such as in a steam generator to further reduce the flue gas temperature thus reducing the grade of metallurgy required in the filter 110. The temperature of the flue gas should be maintained above 400° F. (204° C.) to avoid SOₓ condensation that can produce corrosive sulfuric acid.

The separated flue gas to the compressor may be cooled to below 500° F. (260° C.) such as in a finned tube cooler or other suitable cooling means, so the separated flue gas is at an appropriate temperature for the equipment comprising the compressor 70. Keeping the flue gas below 750° F. (399° C.) will allow the equipment to be made of carbon steel. The separated flue gas may be delivered to a compressor 70 for compression and recycle to the regenerator 14. The compressor should compress the separated flue gas from about 20 psig (137 kPa) to about 28 psig (193 kPa) up to at least between about 30 psig (207 kPa) to about 50 psig (345 kPa) and often about 75 psig (518 kPa). The separated flue gas with catalyst separated from it may comprise no more than 50 wppm catalyst, suitably no more than 10 wppm catalyst and preferably no more than 5 wppm catalyst if catalyst is separated from the flue gas in a filter 110. The compressor 70 is in downstream communication with the flue gas line 48 and the separator which in the FIGURE is the TSS 80 and primarily the barrier filter 110. The separated flue gas is compressed after catalyst is separated from it and recycled to the regenerator 14. Removal of the catalyst ensures that the blades of the compressor 70 are not damaged by the catalyst particles.

A compressor line 72 in downstream communication with the compressor 70 recycles compressed flue gas to the regenerator 14. The regenerator 14 may be in downstream communication with the compressor line 72 and the compressor 70. The compressed, recycled flue gas with regenerated catalyst separated from it may be recycled to the regenerator 14 in the compressor line 72. The compressor line may deliver flue gas to a manifold 74 that provides flue gas to one, two or all of the regenerator vessel 19, the catalyst cooler 50 or the regenerator conduit 18 to fluidize catalyst in the regenerator 14. The compressed, flue gas recycled to the regenerator 14 in compressor line 72 may have the same catalyst concentration as the separated, flue gas to the compressor in line 112.

The regenerator 14 comprises the regenerator vessel 19 and recycling the flue gas includes distributing the flue gas in the regenerator vessel 19 to fluidize the catalyst in the regenerator 14. The regenerator vessel 19 may be in downstream communication with the compressor line 72, the compressor 70 and/or the separator which in the FIGURE comprises the TSS 80 and primarily the filter 110. Regenerator vessel return line 64 transports compressed flue gas from compressor line 72 through the regenerator manifold 74 to the regenerator vessel 19. The regenerator vessel line 64 feeds flue gas to a distributor 78 in the regenerator vessel 19 to distribute flue gas to the regenerator vessel 19 thereby fluidizing regenerated catalyst or catalyst undergoing regeneration in the regenerator vessel 19. The distributor 78 provides fluffing fluidizing gas to the regenerator vessel 19 to remove entrained flue gas from the catalyst and to fluidize catalyst to facilitate its removal from the regenerator vessel 19. The regenerator vessel 19 may be in downstream communication with regenerator vessel return line 64.

In the embodiment of the FIGURE, in which the regenerator 14 comprises a combustor style regenerator vessel 19 that includes the upper chamber 42 and the lower chamber 40, the regenerator vessel return line 64 connects to the upper chamber 42 to distribute compressed flue gas to and fluidize catalyst in the upper chamber 42. Fluidization of catalyst in the upper chamber 42 facilitates its removal through the regenerator conduit 18, the catalyst cooler 50 or a recycle catalyst conduit that is not shown but recycles hot regenerated catalyst from the upper chamber 42 to the lower chamber 40 to help heat cooler spent catalyst delivered to the lower chamber 14 in spent catalyst conduit 36.

The regenerator 14 includes the regenerator conduit 18 for transporting the regenerated catalyst from the regenerator vessel 19 of the regenerator 14 to the riser 20 of the reactor 12. In an aspect, the regenerator conduit 18 transports the regenerated catalyst from the upper chamber 42 of the regenerator vessel 19 to the riser 20. The regenerator conduit 18 may be in downstream communication with a conduit return line 66. Recycling the flue gas to the regenerator 14 comprises transporting the flue gas in a conduit return line 66 to the regenerator conduit 18 and distributing the recycled flue gas to the regenerator conduit 18. Conduit return line 66 transports compressed flue gas from compressor line 72 through the regenerator manifold 74 to the regenerator conduit 18. The conduit return line 66 distributes flue gas to one or more locations such as blast connections and fluidization points in the regenerator conduit 18 to fluidize regenerated catalyst in the regenerator conduit 18 in transport to the riser 20.

The regenerator 14 may include a catalyst cooler 50 for cooling regenerated catalyst. In an aspect, the catalyst cooler 50 cools the hot, regenerated catalyst from the upper chamber 42 of the regenerator vessel 19 and, in the embodiment of the FIGURE, cooled regenerated catalyst is returned to the lower chamber 40 of the regenerator vessel 19. The catalyst cooler 50 may be in downstream communication with a cooler return line 68. Recycling the flue gas comprises transporting the flue gas in the cooler return line 68 to the catalyst cooler 50. The cooler return line 68 recycles flue gas to the distributor 62 which distributes the recycled flue gas to the fluidization lances 60 of the catalyst cooler 50 to fluidize catalyst in the catalyst cooler 50. The cooler return line 68 transports compressed flue gas from compressor line 72 through the regenerator manifold 74 to the cooler distributor 62. The catalyst cooler 50 may be in downstream communication with the cooler return line 68 which provides flue gas to the distributor 62 to distribute flue gas to the fluidization lances 60 in the catalyst cooler 50. Flue gas is distributed along the fluidization lances to fluidize catalyst in the catalyst cooler to facilitate heat transfer from the hot regenerated catalyst to the water in the cooling tubes 54, 56 and to facilitate exit from the catalyst cooler 50 through inlet 50i or outlet 50o as shown in the FIGURE.

Substituting all or part of the fluidization air traditionally used in catalyst fluidization distributors and catalyst cooler fluidization lances with flue gas reduces the entrained inert gases that may make its way into the reactor 12 and eventually require removal in off gas streams in the FCC product recovery section thereby reducing required capacity on product recovery equipment and assuring that undesirable byproducts are not provided from off-gas treating units. By using flue gas for regenerator fluidization, excess oxygen in the flue gas from the regenerator 14 in flue gas line 48 can be reduced from for example from about 2 wt % to no more than about 0.7 wt % while running in full combustion mode. In full combustion mode, at least 99 wt % of the carbon oxides in the discharged flue gas is carbon dioxide. Therefore, the substitution of flue gas for fluidization air also reduces the potential for after burn in the dilute phase of catalyst such as in the upper chamber 42 of the regenerator vessel 19. Additionally, if the regenerator is operated in a partial combustion mode, in which less than 99 wt % of the carbon oxides in the discharged flue gas is carbon dioxide the excess oxygen in the flue gas may be below 0.1 wt %. In partial combustion mode the ratio of carbon dioxide to carbon monoxide may be between about 1 and about 4.

### Specific Embodiments

While the following is described in conjunction with specific embodiments, it will be understood that this description is intended to illustrate and not limit the scope of the preceding description and the appended claims.

A first embodiment of the invention is a process for regenerating catalyst comprising combusting coke from spent catalyst in a regenerator to provide regenerated catalyst and flue gas; discharging flue gas from the regenerator; separating catalyst from the flue gas discharged from the regenerator; and recycling the flue gas to the regenerator. An embodiment of the invention is one, any or all of prior embodiments in this paragraph up through the first embodiment in this paragraph further comprising compressing the flue gas discharged from the regenerator before recycling the flue gas to the regenerator. An embodiment of the invention is one, any or all of prior embodiments in this paragraph up through the first embodiment in this paragraph further comprising removing catalyst from the flue gas discharged from the regenerator before recycling the flue gas to the regenerator. An embodiment of the invention is one, any or all of prior embodiments in this paragraph up through the first embodiment in this paragraph further comprising compressing the flue gas after catalyst is separated from it to recycle the flue gas to the regenerator. An embodiment of the invention is one, any or all of prior embodiments in this paragraph up through the first embodiment in this paragraph further removing catalyst from the flue gas discharged from the regenerator by cyclonic separation. An embodiment of the invention is one, any or all of prior embodiments in this paragraph up through the first embodiment in this paragraph further comprising removing catalyst from the flue gas discharged from the regenerator by filtration. An embodiment of the invention is one, any or all of prior embodiments in this paragraph up through the first embodiment in this paragraph wherein the regenerator comprises a regenerator vessel and recycling includes distributing the flue gas in the regenerator vessel. An embodiment of the invention is one, any or all of prior embodiments in this paragraph up through the first embodiment in this paragraph further comprising combusting coke from the spent catalyst in a lower chamber of the regenerator vessel and disengaging catalyst from flue gas in an upper chamber of the regenerator and the distribution of the flue gas in the regenerator is distributed in the upper chamber. An embodiment of the invention is one, any or all of prior embodiments in this paragraph up through the first embodiment in this paragraph wherein the regenerator includes a regenerator conduit and further comprising transporting the regenerated catalyst to a reactor in the regenerator conduit and wherein the recycling includes distributing the flue gas to the regenerator conduit. An embodiment of the invention is one, any or all of prior embodiments in this paragraph up through the first embodiment in this paragraph wherein the regenerator includes a catalyst cooler and further comprising transporting catalyst from the regenerator to a catalyst cooler and the recycling includes distributing the flue gas to the catalyst cooler to fluidize catalyst in the catalyst cooler.

A second embodiment of the invention is a process for regenerating catalyst comprising combusting coke from spent catalyst in a regenerator of an FCC unit to provide regenerated catalyst and flue gas; contacting the regenerated catalyst with hydrocarbon feed in the FCC unit to provide cracked products and spent catalyst; discharging flue gas from the regenerator; separating regenerated catalyst from the flue gas discharged from the regenerator; and compressing the flue gas. An embodiment of the invention is one, any or all of prior embodiments in this paragraph up through the second embodiment in this paragraph further comprising recycling the flue gas to the FCC unit. An embodiment of the invention is one, any or all of prior embodiments in this paragraph up through the second embodiment in this paragraph further comprising separating regenerated catalyst from the flue gas discharged from the regenerator by filtering catalyst from the flue gas and then compressing the flue gas. An embodiment of the invention is one, any or all of prior embodiments in this paragraph up through the second embodiment in this paragraph further comprising separating catalyst from the flue gas discharged from the regenerator by cyclonic separation. An embodiment of the invention is one, any or all of prior embodiments in this paragraph up through the second embodiment in this paragraph wherein the recycling includes distributing the flue gas in the regenerator. An embodiment of the invention is one, any or all of prior embodiments in this paragraph up through the second embodiment in this paragraph further comprising combusting coke from the spent catalyst in a lower chamber of the regenerator vessel and disengaging catalyst from flue gas in an upper chamber of the regenerator and the distributing the flue gas in the regenerator is distributed in the upper chamber. An embodiment of the invention is one, any or all of prior embodiments in this paragraph up through the second embodiment in this paragraph further comprising transporting the regenerated catalyst to a reactor in a conduit and wherein the recycling includes distributing the flue gas to the conduit. An embodiment of the invention is one, any or all of prior embodiments in this paragraph up through the second embodiment in this paragraph further comprising transporting catalyst from the regenerator to a catalyst cooler and the recycling includes distributing the flue gas to the catalyst cooler to fluidize catalyst in the catalyst cooler.

A third embodiment of the invention is a process for regenerating catalyst comprising combusting coke from spent catalyst in a regenerator vessel to provide regenerated catalyst and flue gas; contacting the regenerated catalyst with hydrocarbon feed to provide cracked products and spent catalyst; discharging flue gas from the regenerator vessel; separating catalyst from the flue gas; compressing the flue gas; and recycling the flue gas to the regenerator vessel. An embodiment of the invention is one, any or all of prior embodiments in this paragraph up through the third embodiment in this paragraph further comprising separating the catalyst from the flue gas by filtration.

A fourth embodiment of the invention is an apparatus for regenerating catalyst comprising a regenerator for combusting coke from spent catalyst; a flue gas line in communication with the regenerator for discharging flue gas; and a compressor in downstream communication with the flue gas line; and the regenerator in downstream communication with the compressor. An embodiment of the invention is one, any or all of prior embodiments in this paragraph up through the fourth embodiment in this paragraph further comprising a separator in communication with the flue gas line for separating catalyst from the flue gas. An embodiment of the invention is one, any or all of prior embodiments in this paragraph up through the fourth embodiment in this paragraph further comprising a return line in downstream communication with the compressor. An embodiment of the invention is one, any or all of prior embodiments in this paragraph up through the fourth embodiment in this paragraph wherein the regenerator includes a regenerator vessel in downstream communication with the return line. An embodiment of the invention is one, any or all of prior embodiments in this paragraph up through the fourth embodiment in this paragraph wherein the regenerator vessel includes an upper chamber and a lower chamber and a return line connects to the upper chamber. An embodiment of the invention is one, any or all of prior embodiments in this paragraph up through the fourth embodiment in this paragraph further comprising a reactor in downstream communication with a regenerator vessel of the regenerator and a regenerator conduit has an inlet end connecting to a regenerator vessel and an outlet end of the regenerator conduit connecting to the reactor and the regenerator conduit is in downstream communication with the return line. An embodiment of the invention is one, any or all of prior embodiments in this paragraph up through the fourth embodiment in this paragraph further including a catalyst cooler in communication with the regenerator vessel and the return line. An embodiment of the invention is one, any or all of prior embodiments in this paragraph up through the fourth embodiment in this paragraph wherein the separator is a barrier filter. An embodiment of the invention is one, any or all of prior embodiments in this paragraph up through the fourth embodiment in this paragraph further comprising a separator with a plurality of cyclone separators in downstream communication with the regenerator and the compressor is in downstream communication with the separator. An embodiment of the invention is one, any or all of prior embodiments in this paragraph up through the fourth embodiment in this paragraph wherein a barrier filter is in downstream communication with the separator vessel.

A fifth embodiment of the invention is an apparatus for regenerating catalyst comprising a regenerator for combusting coke from spent catalyst; a flue gas line in communication with the regenerator for discharging flue gas; a separator in downstream communication with the regenerator; a compressor in downstream communication with the flue gas line; and the regenerator in downstream communication with the compressor. An embodiment of the invention is one, any or all of prior embodiments in this paragraph up through the fifth embodiment in this paragraph wherein the regenerator includes a regenerator vessel in downstream communication with the compressor. An embodiment of the invention is one, any or all of prior embodiments in this paragraph up through the fifth embodiment in this paragraph wherein the regenerator vessel includes an upper chamber and a lower chamber and a return line in downstream communication with the compressor connects to the upper chamber. An embodiment of the invention is one, any or all of prior embodiments in this paragraph up through the fifth embodiment in this paragraph further comprising a reactor in downstream communication with a regenerator vessel of the regenerator and a regenerator conduit has an inlet end connecting to the regenerator vessel and an outlet end of the regenerator conduit connecting to the reactor and the regenerator conduit is in downstream communication with the compressor. An embodiment of the invention is one, any or all of prior embodiments in this paragraph up through the fifth embodiment in this paragraph further including a catalyst cooler in communication with the regenerator vessel and the compressor. An embodiment of the invention is one, any or all of prior embodiments in this paragraph up through the fifth embodiment in this paragraph further comprising a separator in downstream communication with the regenerator and the compressor is in downstream communication with the separator. An embodiment of the invention is one, any or all of prior embodiments in this paragraph up through the fifth embodiment in this paragraph wherein the separator is a barrier filter.

A sixth embodiment of the invention is an apparatus for regenerating catalyst comprising a regenerator for combusting coke from spent catalyst; a flue gas line in communication with the regenerator for discharging flue gas; a separator in communication with the flue gas line for separating catalyst from the flue gas; and a compressor in downstream communication with the separator; and the regenerator is in downstream communication with the compressor. An embodiment of the invention is one, any or all of prior embodiments in this paragraph up through the sixth embodiment in this paragraph further comprising one of a regenerator vessel, a regenerator conduit and a catalyst cooler in downstream communication with the compressor. An embodiment of the invention is one, any or all of prior embodiments in this paragraph up through the sixth embodiment in this paragraph wherein the separator comprises a cyclone separator, a barrier filter, a scrubber or an electrostatic precipitator.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. An apparatus for regenerating catalyst comprising:
a regenerator for combusting coke from spent catalyst;
a flue gas line in communication with said regenerator for discharging flue gas; and
a compressor in downstream communication with said flue gas line; and
said regenerator in downstream communication with said compressor.

2. The apparatus of claim 1 further comprising a separator in communication with said flue gas line for separating catalyst from said flue gas.

3. The apparatus of claim 2 further comprising a return line in downstream communication with said compressor.

4. The apparatus of claim 3 wherein said regenerator includes a regenerator vessel in downstream communication with said return line.

5. The apparatus of claim 3 wherein said regenerator vessel includes an upper chamber and a lower chamber and a return line connects to said upper chamber.

6. The apparatus of claim 3 further comprising a reactor in downstream communication with a regenerator vessel of said regenerator and a regenerator conduit has an inlet end connecting to a regenerator vessel and an outlet end of said regenerator conduit connecting to said reactor and said regenerator conduit is in downstream communication with said return line.

7. The apparatus of claim 3 further including a catalyst cooler in communication with said regenerator vessel and said return line.

8. The apparatus of claim 2 wherein said separator is a barrier filter.

9. The apparatus of claim 1 further comprising a separator with a plurality of cyclone separators in downstream communication with said regenerator and said compressor is in downstream communication with said separator.

10. The apparatus of claim 9 wherein a barrier filter is in downstream communication with said separator vessel.

11. An apparatus for regenerating catalyst comprising:
a regenerator for combusting coke from spent catalyst;
a flue gas line in communication with said regenerator for discharging flue gas;
a separator in downstream communication with said regenerator; and
a compressor in downstream communication with said flue gas line; and
said regenerator in downstream communication with said compressor.

12. The apparatus of claim 11 wherein said regenerator includes a regenerator vessel in downstream communication with said compressor.

13. The apparatus of claim 12 wherein said regenerator vessel includes an upper chamber and a lower chamber and a return line in downstream communication with said compressor connects to said upper chamber.

14. The apparatus of claim 11 further comprising a reactor in downstream communication with a regenerator vessel of said regenerator and a regenerator conduit has an inlet end connecting to said regenerator vessel and an outlet end of said regenerator conduit connecting to said reactor and said regenerator conduit is in downstream communication with said compressor.

15. The apparatus of claim 11 further including a catalyst cooler in communication with said regenerator vessel and said compressor.

16. The apparatus of claim 11 further comprising a separator in downstream communication with said regenerator and said compressor is in downstream communication with said separator.

17. The apparatus of claim 16 wherein said separator is a barrier filter.

18. An apparatus for regenerating catalyst comprising:
a regenerator for combusting coke from spent catalyst;
a flue gas line in communication with said regenerator for discharging flue gas;
a separator in communication with said flue gas line for separating catalyst from said flue gas; and
a compressor in downstream communication with said separator; and
said regenerator is in downstream communication with said compressor.

19. The apparatus of claim 18 further comprising one of a regenerator vessel, a regenerator conduit and a catalyst cooler in downstream communication with said compressor.

20. The apparatus of claim 19 wherein said separator comprises a cyclone separator, a barrier filter, a scrubber or an electrostatic precipitator.
